(19) United States
(12) Patent Application Publication
(10) Pub. No.: US 2026/0127414 A1
(43) Pub. Date: May 7, 2026

(54) METHOD OF OPTIMIZING NETWORK BY USING FEATURE EXTRACTED FROM NETWORK AND ELECTRONIC DEVICE FOR PERFORMING THE METHOD

(71) Applicant: SAMSUNG ELECTRONICS CO., LTD., Suwon-si (KR)

(72) Inventors: Juhwan SONG, Suwon-si (KR); Hoesang CHOI, Suwon-si (KR); Minsuk CHOI, Suwon-si (KR); Seowoo JANG, Suwon-si (KR); Ahyun LEE, Suwon-si (KR); Sanghyun LEE, Suwon-si (KR); Yujin NAM, Suwon-si (KR); Hyunjee KIM, Suwon-si (KR); Daejin KIM, Suwon-si (KR)

(73) Assignee: SAMSUNG ELECTRONICS CO., LTD., Suwon-si (KR)

(21) Appl. No.: 19/380,197

(22) Filed: Nov. 5, 2025

Related U.S. Application Data
(63) Continuation of application No. PCT/KR2025/016565, filed on Oct. 20, 2025.

(30) Foreign Application Priority Data
Nov. 6, 2024 (KR) 10-2024-0156468
Apr. 14, 2025 (KR) 10-2025-0048364

(51) Int. Cl. G06N 3/0455; G06F 18/23213; G06N 3/084; G06N 5/04; H04L 43/04

(52) U.S. Cl. CPC G06N 3/0455; G06F 18/23213; G06N 3/084; G06N 5/04; H04L 43/04

(57) ABSTRACT

A method includes: obtaining network entity data associated with each network entity, from each of one or more network entities; generating, using an encoder model, network embeddings for the one or more network entities, based on the network entity data; converting, using a transformation model, the network embeddings into a predefined number of parameters; inputting the predefined number of parameters to an inference model; obtaining, from the inference model, an output regarding the predefined number of parameters; and determining, based on the output of the inference model, one or more parameters associated with control of a network.

### CROSS-REFERENCE TO RELATED APPLICATIONS

This application is a by-pass continuation application of International Application No. PCT/KR2025/016565, filed on Oct. 20, 2025, which is based on and claims priority to Korean Patent Application No. 10-2024-0156468, filed on Nov. 6, 2024, and Korean Patent Application No. 10-2025-0048364, filed on Apr. 14, 2025, in the Korean Intellectual Property Office, the disclosures of which are incorporated by reference herein their entireties.

### BACKGROUND

### 1. Field

The disclosure relates to a wireless communication method and a wireless communication electronic device, and more particularly, to a method of optimizing a network by using a feature extracted from the network and an electronic device for performing the method.

### 2. Description of Related Art

Wireless communication technologies have been developed mainly for services targeting humans, such as voice calls, multimedia services, and data services. Since the 5th generation (5G) communication systems have been developed, a number of connected devices or devices connected to communication networks, has been grown and increased. Examples of the devices connected to networks may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as ‘beyond-5G systems’

6G communication systems will have a peak data rate of tera (1,000 giga)-level bps and a radio latency of less than 100 μsec, and thus, will be 50 times as fast as 5G communication systems and have 1/10 the radio latency of 5G communication systems.

In order to accomplish such high data rate and ultra-low latency, it has been considered to implement 6G communication systems in a terahertz band (e.g., 95 GHz to 3 THz bands). due to more severe path loss and atmospheric absorption in the terahertz bands than those in mmWave bands introduced in 5G, technologies capable of securing the signal transmission distance (i.e., coverage) will become more crucial. It is necessary to develop, as major technologies for securing coverage, radio frequency (RF) elements, antennas, novel waveforms having better coverage than orthogonal frequency division multiplexing (OFDM), beamforming and massive multiple input multiple output (MIMO), full dimensional MIMO (FD-MIMO), array antennas, and multi-antenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; a use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

Research and development of 6G communication systems in hyper-connectivity, including ‘person to machine’ (P2M) as well as ‘machine to machine’ (M2M), will allow the next hyper-connected experience. Particularly, services such as truly immersive ‘extended reality’ (XR), high-fidelity mobile hologram, and digital replica could be provided through 6G communication systems. In addition, services such as remote surgery for security and reliability enhancement, industrial automation, and emergency response will be provided through the 6G communication systems such that the technologies could be applied in various fields such as industry, medical care, automobiles, and home appliances.

### SUMMARY

According to an aspect of the disclosure, a method includes: obtaining network entity data associated with each network entity, from each of one or more network entities; generating, using an encoder model, network embeddings for the one or more network entities, based on the network entity data; converting, using a transformation model, the network embeddings into a predefined number of parameters; inputting the predefined number of parameters to an inference model; obtaining, from the inference model, an output regarding the predefined number of parameters; and determining, based on the output of the inference model, one or more parameters associated with control of a network.

According to an aspect of the disclosure, an electronic device includes: at least one processor; and memory storing one or more instructions, wherein the one or more instructions, when executed by the at least one processor individually or collectively, cause the electronic device to: obtain, from each of one or more network entities, network entity data associated with each network entity; generate, using an encoder model, network embeddings for the one or more network entities, based on the network entity data; convert, using a transformation model, the network embeddings into a predefined number of parameters; input the predefined number of parameters to an inference model; obtain, from the inference model, an output regarding the predefined number of parameters; and determine, based on an output of the inference model, one or more parameters associated with control of a network.

According to an embodiment of the disclosure, a computer-readable recording medium may have recorded thereon a program for performing any combination of methods, steps, operations, or functions according to an embodiment of the disclosure, on a computer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a wireless communication system, according to an embodiment of the disclosure;

FIG. 2 illustrates an example of network optimization using a feature extracted from a network, according to an embodiment of the disclosure;

FIGS. 3A and 3B illustrate an example of network optimization, according to an embodiment of the disclosure;

FIG. 4 illustrates an example of an encoder model, according to an embodiment of the disclosure;

FIG. 5 illustrates an example of a transformation model, according to an embodiment of the disclosure;

FIG. 6 illustrates an example of training an encoder model, according to an embodiment of the disclosure;

FIG. 7 illustrates an example of training a transformation model and an inference model, according to an embodiment of the disclosure;

FIG. 8 illustrates an example of optimizing a policy of a base station, according to an embodiment of the disclosure;

FIG. 9 illustrates an example of a block diagram of an electronic device, according to an embodiment of the disclosure; and

FIG. 10 illustrates an example of a flowchart of a method, according to an embodiment of the disclosure.

### DETAILED DESCRIPTION

The terms used herein are those general terms currently widely used in the art in consideration of functions in the disclosure but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein are defined based on the unique meanings of the specific terms and the whole context of the disclosure.

The terms used herein are for the purpose of describing certain embodiments only and are not intended to be limiting of the disclosure. The singular forms “a,” “an,” and “the” are intended to include the plural forms as well, unless the context clearly indicates otherwise. The terms used herein, including technical or scientific terms, may have the same meaning as commonly understood by one of ordinary skill in the art described in the disclosure. General terms defined by dictionaries have meanings which may be contextually understood in the art and do not have ideally or excessively formal meanings, when the terms are not defined particularly herein by the disclosure. In some cases, even terms defined in this disclosure are not interpreted to exclude the embodiments of the disclosure.

In one or more embodiments of the disclosure described below, a hardware approach is described as an example. However, because one or more embodiments of the disclosure include technology using both hardware and software, one or more embodiments of the disclosure do not exclude a software-based approach.

The singular forms “a,” “an,” and “the” are intended to include the plural forms as well, unless the context clearly indicates otherwise. The terms used herein, including technical or scientific terms, may have the same meaning as commonly understood by one of ordinary skill in the art described in the disclosure.

In the disclosure, when a portion “includes” an element, another element may be further included, rather than excluding the existence of the other element, unless otherwise described. In addition, the terms “-er”, “-or”, and “module” described in the specification mean units for processing at least one function and/or operation and may be implemented by hardware components or software components or combinations of the hardware components and the software components.

The expression “configured (or set) to” used in the disclosure may be replaced with, for example, “suitable for,” “having the capacity to,” “designed to,” “adapted to,” “made to,” or “capable of” according to a situation. The expression “configured (or set) to” does not always mean only “specifically designed to” by hardware. Alternatively, in some situations, the expression “system configured to” may mean that the system is “capable of” operating together with another device or component. For example, “a processor configured (or set) to perform A, B, and C” may be a dedicated processor (e.g., an embedded processor) for performing a corresponding operation or a generic-purpose processor that may perform a corresponding operation by executing at least one software program stored in memory.

Also, in the disclosure, it will be understood that when elements are “connected” or “coupled” to each other, the elements may be directly connected or coupled to each other, but may alternatively be connected or coupled to each other with an intervening element there between, unless specified otherwise.

Also, in the disclosure, the expression such as “greater than” or “less than” may be used to determine whether a particular condition is satisfied or fulfilled, but this is only an example and the expression may not exclude the description of “equal to or greater than” or “equal to or less than”. A condition written with “equal to or greater than” may be replaced with “greater than”, a condition with “equal to or less than” may be replaced with “less than”, and a condition with “equal to or greater than . . . and less than . . . ” may be replaced with “greater than . . . and equal to or less than . . . ”.

The disclosure uses terms and names defined in the 3^{rd}-generation partnership project (3GPP) long-term evolution (LTE) or new radio (NR) standard, or terms and names that are modifications defined in the 3GPP LTE or NR standard. However, the disclosure may not be limited to the terms and names and may also be applied to systems following other standards. In the disclosure, eNode B (eNB) may be interchangeably used with gNode B (gNB). For example, a base station referred to as an eNB may also indicate a gNB. Furthermore, the term ‘terminal’ may refer not only to a user equipment (UE), a mobile station (MS), a mobile phone, a narrowband-Internet of things (NB-IoT) device, and a sensor but also to other wireless communication devices.

In an embodiment, an ‘artificial intelligence (AI) model’ may be an algorithm, a system, or a model designed to analyze given input data and perform a specific task. For example, the AI model may be an algorithm, a system, or a model that learns patterns from input data and performs inference such as prediction, classification, or decision making. The AI model may include an explicit rule-based algorithm, a machine learning model, and a deep learning model. The AI model may learn patterns from training data and improve its performance on its own.

In an embodiment, ‘machine learning’ may be a technique of learning from given data, generalizing to unseen data, and performing tasks without explicit instructions. The machine learning may include, but is not limited to, supervised learning, unsupervised learning, semi-supervised learning, and/or reinforcement learning. Through the machine learning, one or more weights and/or parameters of an AI model may be optimized. For example, the AI model may improve the performance of the model by adjusting weights and parameters during a learning (or training) process. During learning, the AI model may update weights and parameters to minimize a loss or cost value. The AI model learned or trained through the machine learning may be referred to as an ‘ML model’ or an ‘AI/ML model’.

In an embodiment, a ‘deep learning model’ may be an AI model including a plurality of neural network layers. Each neural network layer may include one or more neurons, and each neuron may include one or more weights optimized through learning. Neurons of one layer may perform operations between operation results (or outputs) of a previous layer and corresponding weights of the current layer. Through these operations, the deep learning model may learn data and may extract a feature from input data. The ‘deep learning model’ may be referred to as a ‘neural network model’.

In an embodiment, the terms ‘AI model’, ‘ML model’, ‘AI/ML model’, ‘deep learning model’, and ‘neural network model’ may be interchangeably used.

In an embodiment, the AI model may include any of various AI/ML models such as, but not limited to, linear regression, logistic regression, Gaussian mixture model (GMM), support vector machine (SVM), latent Dirichlet allocation (LDA), decision tree, convolutional neural network (CNN), long short-term memory (LSTM), deep neural network (DNN), recurrent neural network (RNN), restricted Boltzmann machine (RBM), deep belief network, bidirectional recurrent deep neural network (BRDNN), transformer, deep Q-networks (DQN), or proximal policy optimization (PPO).

In the disclosure, a function related to AI is performed by a processor and memory. The processor may include one or more processors. In this case, the one or more processors may be a general-purpose processor, a graphics-specific processor, or an AI-specific processor. The one or more processors may process input data according to predefined operation rules or an AI model stored in the memory. In an embodiment, when the one or more processors are an AI-specific processor, the AI-specific processor may be designed with a hardware structure specialized for processing a particular AI model.

The predefined operation rules or the AI model may be generated through training. Specifically, when the predefined operation rules or the AI model are generated through training, the AI model is trained by using a large amount of training data by a training algorithm to generate the predefined operation rules or the AI model configured to perform a desired characteristic (or purpose). Such training may be performed in a device itself in which AI according to the disclosure is executed or may be performed through a separate server and/or system. In an embodiment, learning or training of the AI model may be performed based on machine learning.

An embodiment of the disclosure will now be described more fully with reference to the accompanying drawings for one of ordinary skill in the art to be able to perform the embodiment of the disclosure without any difficulty. However, the disclosure may be implemented in various different forms and is not limited to the embodiments described herein.

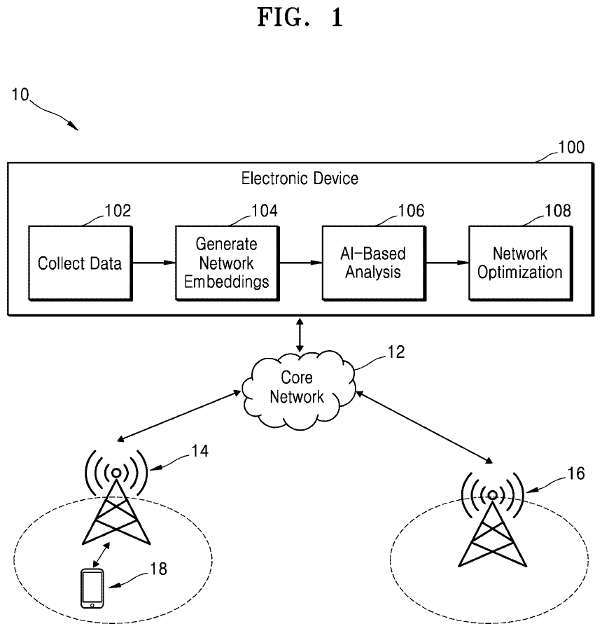

FIG. 1 illustrates an example of a wireless communication system 10, according to an embodiment of the disclosure.

Referring to FIG. 1, an electronic device 100 may collect data from one or more network entities included in a core network 12 and/or one or more network entities connected to the core network 12. The wireless communication system 10 may include various nodes using a wireless channel. For example, the wireless communication system 10 may include the electronic device 100, the core network 12, base stations 14 and 18, and a user equipment (UE) 18. Each of the base stations 14 and 16 may communicate with one or more user terminals in a corresponding cell. A user terminal may communicate with the core network 12 of the wireless communication system 10 through a base station of a cell to which the user terminal belongs. For example, the UE 18 may communicate with the core network 12 through the base station 14. Hereinafter, each component constituting the wireless communication system 10 may be referred to as a network entity.

In an embodiment, the wireless communication system 10 may be a 5^{th} generation (5G) communication system. In the wireless communication system 10, the core network 12 may be referred to as a 5G core network (5GC). The base stations 14 and 16 may each be referred to as an access point (AP), an eNodeB (eNB), a 5G node, a next generation nodeB (gNB), a wireless point, a transmission/reception point (TRP), or another term having the same technical meaning. The base stations 14 and 16 may be network infrastructure or network entities providing wireless access to terminals 104 and 106. Each of the base stations 14 and 16 may have a coverage (or cell) defined as a certain geographic area within which a signal may be transmitted. For data transmission and reception processing of one or more UEs connected to each base station, control signal processing and data signal processing may be performed at each base station.

The UE 18 is used by a user and may communicate with the base station 14 through a wireless channel. A link from the base station 14 to the UE 18 may be referred to as a downlink (DL). A link from the UE 18 to the base station 14 may be referred to as an uplink (UL). The UE 18 may communicate with another UE through a wireless channel. In an embodiment, a device-to-device (D2D) link between UEs may be referred to as a sidelink or a long term evolution (LTE) ‘vehicle-to-everything’ (V2X) PC5 interface.

In an embodiment, the UE 18 may operate without user involvement. For example, the UE 18 may be a device for performing ‘machine-type communication’ (MTC) and may not be carried by the user. The UE 18 may be referred to as a ‘customer premises equipment’ (CPE), a mobile station, a subscriber station, a remote terminal, a wireless terminal, an electronic device, a user device, or another term having the same technical meaning.

The electronic device 100 may optimize one or more network entities in the wireless communication system 10 based on an AI/ML model. The electronic device 100 may collect data associated with data transmission/reception in the wireless communication system 10 from one or more network entities in the wireless communication system 10 (block 102). The electronic device 100 may extract a feature of a network from the collected data and may generate network embeddings representing the extracted feature of the network (block 104). The electronic device 100 may analyze the collected data by using an AI/ML model based on the network embeddings (block 106). The electronic device 100 may perform network optimization based on the AI-based analysis (block 108).

In an embodiment, with the introduction of 5G and network congestion, ‘operational complexity and operational expenditure’ (OPEX) may increase. In order to efficiently operate a network, an AI/ML model may be used to predict a state of the network (or wireless communication system) or optimize one or more parameters used in the network.

The types and ranges of values of network data to be input to the AI/ML model may be very wide or diverse, and it may take a lot of time to collect the network data. Also, in order to train the AI/ML model to suggest optimal parameters, data are obtained by directly applying various parameters in a commercial network. For example, for base station optimization, data may be collected by applying various base station parameters and the collected data may be used to train the AI/ML model. In order to achieve a high performance indicator, training data collection through aggressive parameter recommendation for base stations may be required. However, from a network operation perspective, because an abnormality in one base station may have a chain effect on other base stations, this data acquisition method may degrade user ‘quality of service’ (QoS) and may not be preferred. Accordingly, for stable network operation, values of parameters used for training data collection may be limited, and thus, the performance of AI/ML-based network optimization may also be limited.

Because the amount of data to be collected increases as the number of parameter combinations to be input to the AI/ML model increases, it may be necessary to establish a good collection strategy. For example, considering that it is difficult to collect all combinations and all values through direct substitution, a strategy of quantizing and collecting one or more parameter combinations and/or values may be used. For example, data may be collected by changing a value of a parameter in units of 10 or 20, instead of a unit of one (1). Also, although data augmentation may be used to collect more data based on less data, a change in a parameter value is limited, thereby limiting the improvement of the AI/ML model.

On the other hand, collecting a large amount of data by using a simulator for a communication system (e.g., NS-3 simulator) may be one method. However, due to the nature of the simulator, it may be difficult to perfectly simulate a commercial network. Also, due to the limited computational power, it may take one second or more to obtain data corresponding to one transmission time interval (TTI) (e.g., 1 millisecond (ms)) by using the simulator. For example, it may take 24,000 hours (about 1000 days) to obtain one day's worth of data. Considering that data corresponding to a period equal to or longer than at least one year is required for network operation, collecting data by using the simulator may have limitations.

In an embodiment, instead of directly inputting collected network data to an AI/ML model, the electronic device 100 may first extract a hidden feature of a network from network data and may input the extracted feature to an input layer of the AI/ML model. For example, the electronic device 100 may generate network embeddings representing one or more features of a network from network data and may input the generated network embeddings to an AI/ML model. Accordingly, even when a small amount of training data is used, a training convergence speed of the AI/ML model may be improved, and the performance of the AI/ML model may also be improved.

In an embodiment, a generative AI model may be used to generate network embeddings. For example, the electronic device 100 may generate network embeddings from collected network data, by using at least one of various generative AI models such as an auto encoder (AE), a variational auto encoder (VAE), a diffusion model, and/or a generative adversarial network (GAN).

In an embodiment, the electronic device 100 may use at least one of a supervised learning model, an unsupervised learning model, a reinforcement learning model, and/or a neural network model to analyze network data and determine one or more parameters for network optimization.

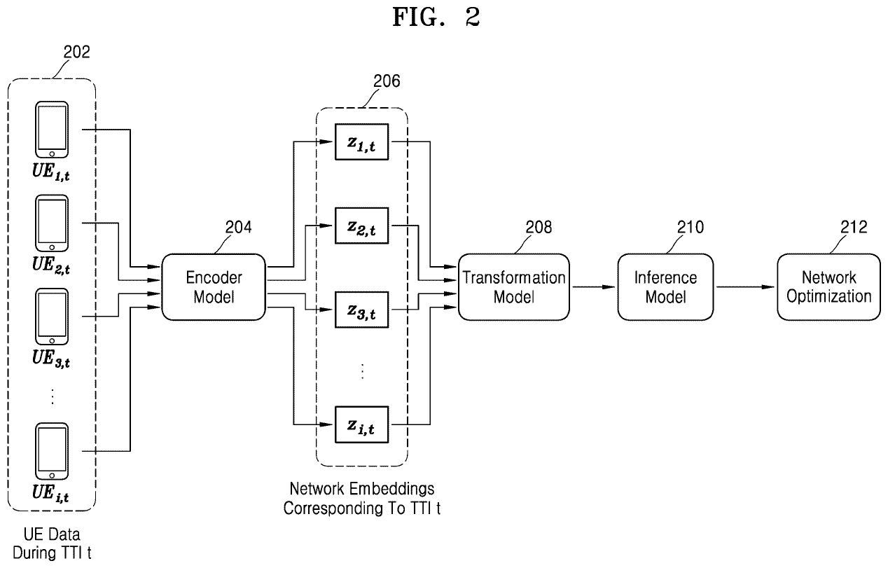

FIG. 2 illustrates an example of network optimization using an inference model, according to an embodiment of the disclosure.

Referring to FIG. 2, in order to optimize a wireless communication system, data collected from one or more network entities included in the wireless communications system or a network may be analyzed by using an inference model 210. In an embodiment, the electronic device 100 may include an encoder model 204, a transformation model 208, and the inference model 210. The electronic device 100 may analyze network data by using the encoder model 204, the transformation model 208, and the inference model 210 and may optimize the network based on an analysis result. For example, in FIG. 2, UE data 202 associated with the wireless communication system may be obtained from one or more UEs. Periodically, aperiodically, or in response to, or based on, one or more predefined triggers, information associated with the wireless communication system and/or wireless network may be obtained from each UE at a specific time point or during a specific time interval. For example, each of the one or more UEs may provide the UE data 202 including the information associated with the wireless communication system and/or the wireless network to, for example, the electronic device 100 of FIG. 1, in each ‘transmission time interval’ (TTI).

In an embodiment, the UE data 202 may include data associated with performance obtained from each UE at a specific time point or during a specific time interval (e.g., reference signal received power (RSRP), reference signal received quality (RSRQ), signal-to-interference-plus-noise ratio (SINR), channel quality indicator (CQI), and/or timing advance (TA)), data associated with network mobility (e.g., data associated with primary cell (PCell) and/or secondary cell (SCell), data associated with aggregation (CA), data associated with handover, data associated with radio resource control (RRC), and/or data associated with neighboring cells), data associated with data processing and traffic (e.g., information associated with downlink and/or uplink throughput, packet loss, and/or latency, and/or information associated with a radio bearer), and/or information related to a UE state (e.g., power consumption, data associated with discontinuous reception (DRX), power headroom reporting, transmission power information, and/or information for identifying a network connected to a UE).

In FIG. 2, the UE data 202 may be collected from one or more UEs (e.g., UE data UE_{1, t} collected from UE 1 during TTI t, . . . UE data UE_{i, t} collected from UE i during TTI t, where i is a natural number) during TTI t. The UE data 202 corresponding to TTI t may be first input to the encoder model 204 before being analyzed by using the inference model 210. Based on the UE data 202 corresponding to TTI t, the encoder model 204 may generate network embeddings 206 corresponding to TTI t.

The encoder model 204 may extract one or more features associated with a network from input data, and may generate network embeddings representing the extracted features. In an embodiment, the term ‘embedding’ may be an operation of extracting a feature from data and representing the feature as a vector or a result of the operation. Through an embedding, high-dimensional unstructured data such as text, an image, a graph, or user data may be converted into low-dimensional structured data such as a numerical vector. For example, an embedding in natural language processing may be an operation of converting a natural language used by a human into a numerical vector that may be understood by a machine, or a conversion result. In an embodiment, based on a natural network being used for feature extraction, an extracted feature may be represented as a neural network embedding vector. For example, a neural network model for an embedding may be trained to convert similar values in input data into similar vector values.

For example, the encoder model 204 may generate a network embedding of representing a feature of a corresponding UE during TTI t from each UE data. The encoder model 204 may extract a feature of a corresponding UE during TTI t from each UE data, and may represent the extracted feature as a latent vector or a latent representation in a latent space. The latent vector or the latent representation corresponding to TTI t for each UE may be referred to as a network embedding corresponding to TTI t of (or associated with) the UE. Based on the UE data UE_{1, t} collected from UE 1 during TTI t, the encoder model 204 may generate a network embedding Z_{1, t} representing a networkfeature of UE 1 during TTI t. In a similar manner, the encoder model 204 may generate network embeddings Z_{2,t}, Z_{3, t}, . . . , Z_{i, t}, based on respective UE data during TTI t.

In an embodiment, the encoder model 204 may be or may correspond to a combination of components that generate a latent vector or a latent representation of a generative AI model. For example, the encoder model 204 may be or may correspond to an encoder model of an encoder-decoder-based generative model such as an auto encoder (AE), a denoising auto encoder (DAE), or a variational autoencoder (VAE), an encoder model or generator model of a generative adversarial network (GAN)-based model, or an encoder model of a diffusion-based model.

The network embeddings 206 corresponding to TTI t, generated by the encoder model 204, may be input to the transformation model 208. The transformation model 208 may convert the network embeddings 206 corresponding to TTI t into a predefined number of parameters. The transformation model 208 may convert input network embeddings into predefined number of parameters, regardless of the number of input network embeddings (e.g., input dimension size). The converted one or more parameters may be input to the inference model 210.

The number of network entities from which data is obtained may vary over time. For example, in an actual wireless communication system, the number of UEs connected to one base station may vary over time due to various reasons such as handover, RRC connection establishment or release, cell coverage change of the base station, load balancing, and/or cell reselection. Accordingly, for example, while data may be obtained from i UEs during TTI t, data may be obtained from “k” UEs during TTI t+1 (“k” is a natural number different from i). Accordingly, the number of network embeddings corresponding to each TTI, generated from the encoder model 204, may also vary. The transformation model 208 may convert input embeddings into a predefined number of parameters, regardless of the number of input embeddings. Accordingly, even when the number of network entities (from which data is collected) changes in the actual wireless communication system, the input dimension size of data input to the inference model 210 through the encoder model 204 and the transformation model 208 may be fixed.

In an embodiment, the transformation model 208 may be implemented based on any algorithm or model that converts an input having a variable length into an output having a predefined dimension (or length). For example, the transformation model 208 may be implemented based on at least one of various models such as a self-attention algorithm or transfer model, an RNN model such as LSTM or gated recurrent unit (GRU), a pooling function such as mean pooling or max pooling, or an encoder model for compressing an input having a variable length into a vector having a fixed size, but embodiments of the disclosure are not limited to the above example embodiment.

The one or more parameters converted by the transformation model 208 may be input to the inference model 210. The inference model 210 may perform inference based on the converted one or more parameters. An output regarding the converted parameters may be obtained from the inference model 210. Network optimization may be performed based on an inference result of the inference model 210 (block 212).

In an embodiment, the inference model 210 may be trained to infer one or more parameters or policies to be used in the wireless communication system based on network data. For example, the inference model 210 may be trained to infer one or more parameters and/or one or more policies regarding network entities belonging to the wireless communication system based on network data collected from the network entities and converted through the encoder model 204 and the transformation model 208. Network optimization may be performed by using the one or more parameters and/or one or more policies inferred by the inference model 210. For example, one or more parameters and/or policies used in the wireless communication system may be modified based on an inference result of the inference model 210.

In an embodiment, the inference model 210 may be trained to predict one or more key performance indicators (KPIs) of the wireless communication system based on network data. For example, the inference model 210 may be trained to predict one or more KPIs regarding network entities belonging to the wireless communication system based on network data that are collected from the network entities, and then, converted through the encoder model 204 and the transformation model 208. Network optimization may be performed by using the one or more KPIs predicted by the inference model 210. For example, one or more parameters and/or policies used in the wireless communication system may be modified based on an inference result of the inference model 210.

In an embodiment, the inference model 210 may be implemented based on at least one of various AI/ML models such as linear regression, logistic regression, random forest, RNN, long short-term memory (LSTM), transformer, deep Q-network (DQN), and/or proximal policy optimization (PPO), but the disclosure is not limited to the above examples.

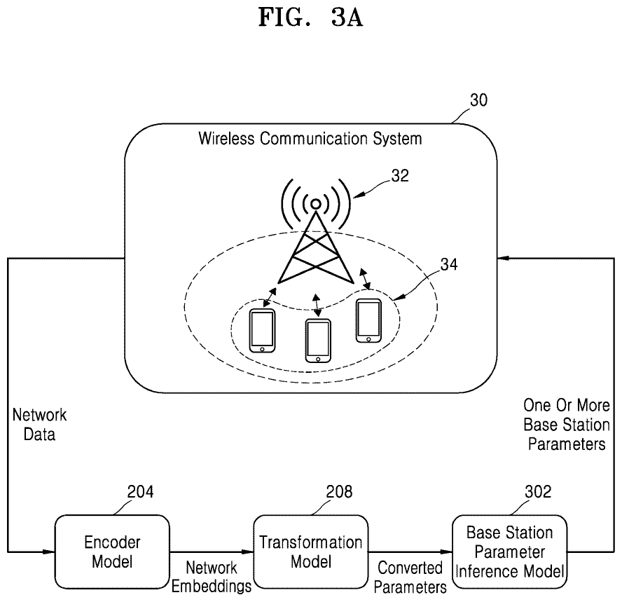

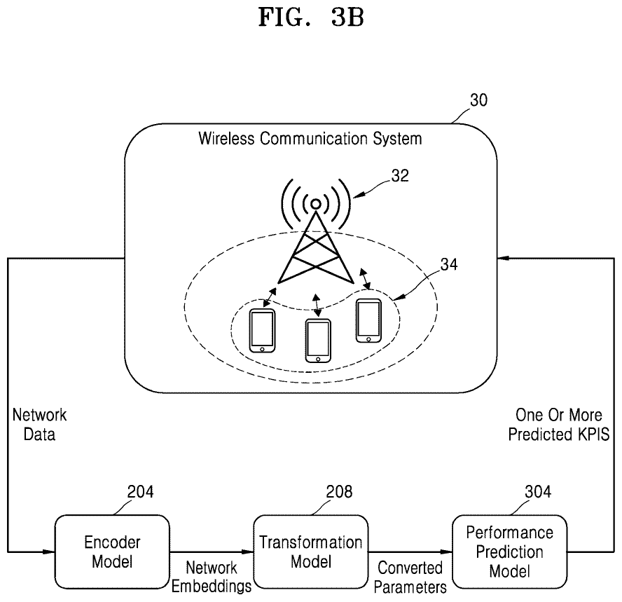

FIGS. 3A and 3B illustrate an example of network optimization, according to an embodiment of the disclosure.

Referring to FIG. 3A, the inference model 210 may be or correspond to an AI/ML model, for example, a base station parameter inference model 302, trained to recommend one or more optimal base station parameters from given network data. A wireless communication system 30 may include a base station 32 and one or more UEs 34. The one or more UEs 34 may be connected to the base station 32. The base station 32 may be included in the wireless communication system 30. The base station 32 may be optimized by using the encoder model 204, the transformation model 208, and the base station parameter inference model 302.

The electronic device 100 may obtain network data (in tabular form) collected from a data collection entity (e.g., an operation administration maintenance (OAM)) of the wireless communication system 30 or network data from a simulator that simulates the wireless communication system 30. The electronic device 100 may generate network embeddings from the given network data through the encoder model 204. The embedded network data may be used for an AI task.

In an embodiment, the embedded network data may be used for configuration measurement (CM)/policy recommendation. For example, the inference model 210 may be used to change base station parameters (e.g., parameters for controlling one or more base stations included in the CM) or to change base station policies to optimize the operation or performance of the base station. Accordingly, embedded graphs (e.g., network embeddings) may be input to the inference model 210, and the inference model 210 may be trained to output the best CM or policy. The inference model 210 may be applied to various tasks such as energy saving, load balancing, connected mode discontinuous reception (C-DRX) optimization, or resource scheduling optimization. In an embodiment, the inference model 210 trained for CM or policy recommendation may be trained based on reinforcement learning.

For example, the wireless communication system 30 may provide network data obtained from at least one of the base station 32 or the one or more UEs 34 to the encoder model 204 periodically, aperiodically, in response to, or based on, a trigger. The encoder model 204 may generate network embeddings based on the network data. The transformation model 208 may convert the network embeddings into a predefined number of parameters (or a vector or a matrix including a predefined number of parameters). The parameters converted by the transformation model 208 may be input to the base station parameter inference model 302 that may infer one or more base station parameters based on the given parameters. The one or more base station parameters output from the base station parameter inference model 302 may be used to determine one or more parameters associated with the base station 32 of the wireless communication system 30. For example, the wireless communication system 30 may change one or more parameters used in the base station 32 into one or more base station parameters inferred by the base station parameter inference model 302.

In an embodiment, various base station parameters used in the base station 32 may be adjusted based on the one or more base station parameters inferred by the base station parameter inference model 302. For example, at least one of various base station parameters such as a base station power state (e.g., turn-on or turn-off), radio frequency-related parameters (e.g., frequency band, bandwidth, transmission power, antenna gain, and/or cell radius), coverage and handover-related parameters (e.g., RSRP, RSRQ, SINR, and/or handover trigger value), capacity and quality of service (QoS)-related parameters (e.g., maximum number of users per cell, the number of physical resource blocks (PRBs), QoS classification identifier, and/or delay requirements), time synchronization and delay-related parameters (e.g., timing advance, propagation delay, hybrid automatic repeat request (HARQ) timer, and/or slot duration), antenna and beamforming-related parameters (e.g., beam switching rate and/or beamwidth), and/or scheduling algorithm parameters (e.g., uplink or downlink target block error rate (BLER) or SINR offset) may be adjusted to a value inferred by the base station parameter inference model 302.

Referring to FIG. 3B, the inference model 210 may be or may correspond to an AI/ML model, for example, a performance prediction model 304, trained to predict performance of a network and/or the wireless communication system 30 from given network data. The wireless communication system 30 may include the base station 32 and one or more UEs 34. The one or more UEs 34 may be connected to the base station 32. Network entities (e.g., the base station 32 and/or the one or more UEs 34) included in the wireless communication system 30 may be optimized by using the encoder model 204, the transformation model 208, and the performance prediction model 304.

In an embodiment, embedded network data may be used for KPI, channel, or traffic estimation. For example, in order to prevent a network state from being degraded, the inference model 210 may be trained to predict a state of the network based on the embedded network data. Accordingly, embedded graphs (e.g., network embedding) may be input to the inference model 210, and the inference model 210 may infer (or predict) a KPI value (e.g., IP throughput, UE throughput, latent throughput, or call drop rate), a channel estimation value (e.g., CQI, SINR, or BLER), and/or a traffic estimation value (e.g., PRB usage and/or downlink/uplink packet data convergence protocol (PDCP) data volume) based on the embedded graphs. The inference model 210 may be applied to various tasks such as root cause analysis or cell planning.

For example, the wireless communication system 30 may provide network data obtained from at least one of the base station 32 or the one or more UEs 34 to the encoder model 204 periodically, aperiodically, in response to, or based on, a trigger. The encoder model 204 may generate network embeddings based on the network data. The transformation model 208 may convert the network embeddings into a predefined number of parameters (or a vector or a matrix including a predefined number of parameters). The parameters converted by the transformation model 208 may be input to the performance prediction model 304. The performance prediction model 304 may predict one or more KPIs associated with the wireless communication system 30 based on the given parameters. The one or more predicted KPIs output from the base station parameter inference model 302 may be used to adjust at least one parameter of network entities of the wireless communication system 30. For example, the wireless communication system 30 may adjust one or more parameters used in the base station 32 and/or the one or more UEs 34 based on the predicted KPIs.

In an embodiment, various parameters used in the base station 32 and/or the UEs 34 may be adjusted based on the one or more predicted KPIs inferred by the performance prediction model 304. The performance prediction model 304 may be trained to predict, from given network data, at least one of various KPIs such as coverage and quality of signal-related indicators (e.g., RSRP, RSRQ, SINR, CQI, modulation and coding scheme (MCS), and/or coverage hole rate), capacity and traffic-related indicators (e.g., cell throughput, user throughput, PRB utilization, traffic load, and/or peak time traffic), handover-related indicators (e.g., cell setup success rate, drop call rate, handover success rate, or RRC setup success rate), delay and QoS-related indicators (e.g., end-to-end delay, packet loss rate, jitter, BLER, and/or QoS satisfaction), and/or energy and operation efficiency-related indicators (e.g., power consumption, DRX cycle length, RRC inactive time, spectral efficiency, and/or network availability). In an embodiment, the inference model 210 trained for KPI prediction may be trained based on a regression model such as linear regression or logistic regression.

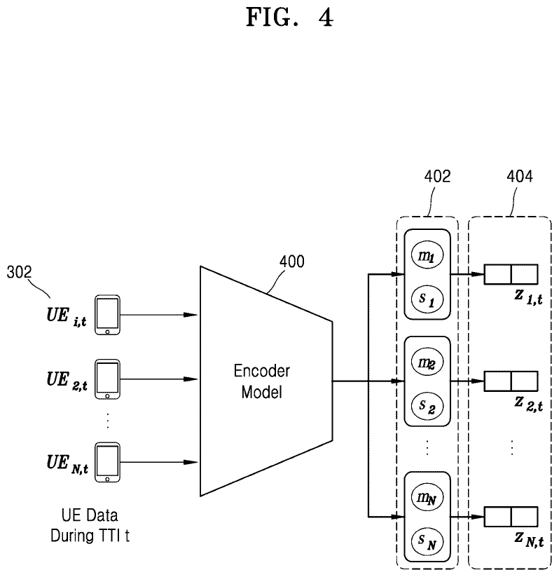

FIG. 4 illustrates an example of an encoder model 400, according to an embodiment of the disclosure.

Referring to FIG. 4, the encoder model 204 of the electronic device 100 may be or may correspond to a VAE-based encoder model 400. For example, the encoder model 400 may be trained to infer a probability distribution representing each UE state variation from given UE data. A latent vector that encapsulates network state structures may be generated based on the probability distribution.

The encoder model 400 may receive the UE data 202 collected from one or more UEs during TTI t. The encoder model 400 may infer a probability distribution 402 for each UE. For example, the encoder model 400 may map a state or data UE_{i, t} of UE i corresponding to TTI t to a latent representation (or embedding) z_{i, t}, as shown in Equation 1:

$${q}_{φ} ( {z}_{i , t} \vert {UE}_{i , t} ) = 𝒩 ( {z}_{i , t} \vert {μ}_{φ} ( {UE}_{i , t} ) , {a}_{t} ) \qquad [ Equation 1 ]$$

Referring to Equation 1, q_{φ} may correspond to the encoder model 400. μ_{φ} (UE_{i,t}) may correspond to a mean of a latent distribution for the network state UE_{i, t}. αₜ may correspond to a variance of the latent representation z_{i,t}. αₜ may adjust a degree of uncertainty. In an embodiment, a value of αₜ may be preset during training of the encoder model 400 or may be dynamically adjusted during inference. A high αₜ value introduces high noise into the latent representation, which may capture high uncertainty in the state of the UE. Accordingly, a flexible latent representation that may adapt to various and complex network conditions may be allowed. A low αₜ value reduces a noise level, which results in a stable and accurate latent representation, and such a latent representation may be beneficial for relatively stable network conditions. In an embodiment, αₜ may be associated with a parameter output from the inference model 210. For example, αₜ may be dynamically adjusted to correspond to a target value to be output by using the inference model 210.

Network embeddings 404 may be generated for UEs through reparameterization based on the probability distributions 402 output from the encoder model 400. During reparameterization, a network embedding may be sampled based on a probability distribution and Gaussian noise for each UE. For example, the network embedding z_{i,t} for UE i corresponding to TTI t may be derived based on Equation 2:

$${z}_{i , t} = {μ}_{φ} ( {UE}_{i , t} ) + \sqrt{{a}_{t}} ϵ , ϵ \sim 𝒩 ( 0 , 1 ) \qquad [ Equation 2 ]$$

Referring to Equation 2, μ_{φ} (UE_{i,t}) and at may correspond to a mean and a variance output from the encoder model 400. ϵ may be standard Gaussian noise. As a αₜ value increases, more noise is introduced into z_{i,t}, which may capture greater uncertainty in the state of the UE, thereby allowing the encoder model 400 to adaptively adjust the latent representation based on the αₜ value.

In an embodiment, a plurality of encoder models may be used to process data collected from a plurality of network entities simultaneously or in parallel. For example, the electronic device 100 may include a plurality of encoder models 400. Network data obtained from different UEs may be respectively input to the plurality of encoder models. For example, data from a first UE may be input to a first encoder model among the plurality of encoder models, and simultaneously, data from a second UE may be input to a second encoder model among the plurality of encoder models. The first encoder model and the second encoder model may simultaneously process the input data. For example, while a network embedding for the first UE is generated, a network embedding for the second UE may also be generated. Accordingly, a processing speed (e.g., embedding speed) of data received from the plurality of network entities may be improved.

By embedding a correlation between a network state and control parameters, the encoder model 400 may help the inference model 210 to interpret network conditions more easily. A structured representation generated by the encoder model 400 may reduce an exploration space, which may allow the inference model 210 to infer optimized policies and/or parameters with fewer trials and errors. Also, latent vectors of the encoder model 400 may capture common patterns between different states, which may facilitate stable learning and fast generalization under uncertain conditions.

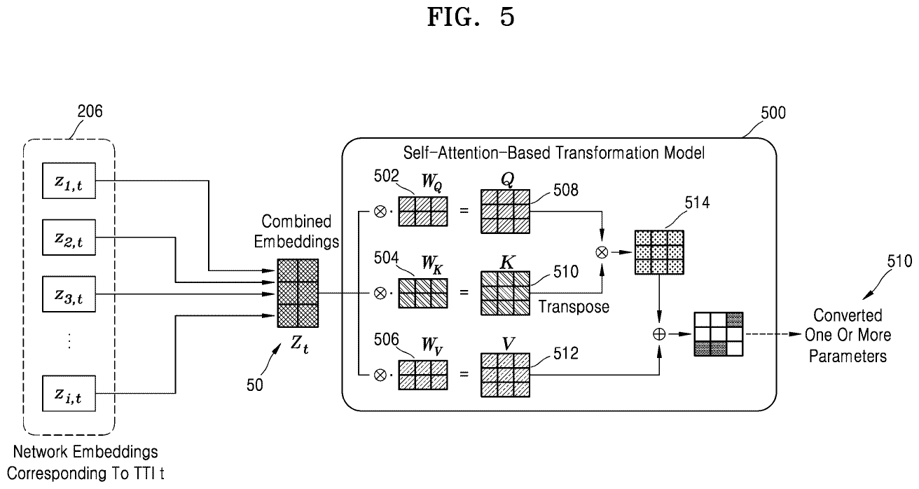

FIG. 5 illustrates an example of a transformation model 500, according to an embodiment of the disclosure.

Referring to FIG. 5, the transformation model 208 of the electronic device 100 may be or may correspond to a self-attention-based transformation model 500. For example, the transformation model 500 may convert the network embeddings 206 generated by the encoder model 204 into a predefined number of parameters based on a self-attention mechanism. In response to, or based on, a number of active UEs varying at each TTI, the self-attention-based transformation model 500 may dynamically handle variable-length embeddings.

The network embeddings corresponding to TTI t, generated by the encoder model 204, may be combined into one vector Zₜ={z_{1, t}, z_{2,t}, . . . , z_{N,t}}. Zₜ may be a set of latent representations (or network embeddings) Z_{i,t}, each generated by the encoder model 204 for each UE i at time t (or TTI t). In an embodiment, Zₜ may be a row vector or a column vector. The combined embedding Zₜ may be input to the transformation model 500. In the transformation model 500, self-attention processing using [symbol] 502, W_{K} 504, and W_{V} 506 may be performed on Zₜ. [symbol] 502 may be referred to as a query weight matrix used for query transformation. W_{K} 504 may be referred to as a key weight matrix used for key transformation. W_{V} 506 may be referred to as a value weight matrix used for value transformation.

The combined embedding Zₜ may be multiplied by each of [symbol] 502, W_{K} 504, and W_{V} 506. A product of [symbol] 502 and Zₜ may be referred to as a query vector [symbol] 208. A product of W_{K} 504 and Zₜ may be referred to as a key vector K. A product of W_{V} 506 and Zₜ may be referred to as a value vector V 512. The query vector [symbol] 508 and the key vector K 510 may undergo a dot product operation. For example, the key vector K may be transposed and multiplied by the query vector [symbol] 508. A softmax function may be applied to the dot product of the query vector [symbol] 508 and the key vector K 510. Finally, the dot product to which the softmax is applied may be multiplied by the value vector V 512. Accordingly, a final output of the transformation model 500 may be calculated. The processing of the transformation model 500 may be understood as shown in Equation 3.

$$Attention ( {Z}_{t} ) = σ ( {W}_{Q} ( {Z}_{t} ) {{W}_{K} ( {Z}_{t} )}^{T} ) {W}_{V} ( {Z}_{t} ) \qquad [ Equation 3 ]$$

Referring to Equation 3, may correspond to a softmax function that generates a probability distribution with respect to attention weights. In an embodiment, the self-attention-based transformation model 500 may output a predefined number of parameters even when the number of input network embeddings varies. For example, even when the number of UEs N, which is a length of Zₜ, varies, the size of an output matrix by a self-attention operation may be fixed. The self-attention mechanism may capture complex inter-UE relationships, which may improve the capability of the inference model 210 even under dynamically changing network conditions. Also, through weight matrices, the transformation model 500 may handle variable input dimensions and leverage inter-UE dependence to optimize network performance.

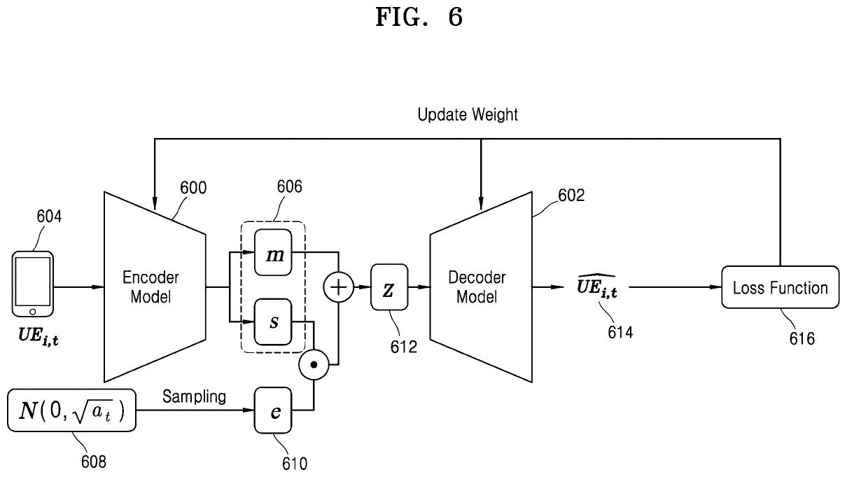

FIG. 6 illustrates an example of training an encoder model 600, according to an embodiment of the disclosure.

Referring to FIG. 6, the encoder model 400 may be obtained by training the encoder model 600 and a decoder model 602. The encoder model 600 and the decoder model 602 may respectively correspond to an encoder model and a decoder model of a VAE. The encoder model 600 may be trained by using training network data 604 obtained from a single UE (e.g., UE i). The training network data 604 may include network data obtained from UE i for each TTI. For example, the training network data 604 may include one or more indicators associated with a traffic or channel state of UE i such as CQI, MCS, SINR, or BLER.

Network data UE_{i, t} obtained from UE i during TTI t may be input to the encoder model 600 for training. The encoder model 600 may infer a probability distribution 606 for UE i from the training network data 604, in a manner similar to that described with reference to Equation 1. The probability distribution 606 may include a mean μ and a variance σ. In order to generate an input to the decoder model 602, noise 610 may be sampled from Gaussian noise 608. Based on the probability distribution 606 and the noise 610, a latent representation z 612 may be computed in a manner similar to that described with reference to Equation 2.

The decoder model 602 may reconstruct information of UE i from the latent representation 612 based on the probability distribution 606 and the noise 610. The decoder model 602 may be trained to reconstruct by removing noise. Reconstructing UE information by removing noise may correspond to removing base station parameter information from given UE data. In an embodiment, the noise 610 may correspond to a base station parameter. As a base station parameter value increases, more noise may be reflected in the latent representation 612, thereby making reconstruction by the decoder model 602 more difficult. The decoder model 602 may generate reconstructed data from the latent presentation 612 based on Equation 4.

$${p}_{ψ} ( {UE}_{i , t} \vert {z}_{i , t} ) = 𝒩 ( {UE}_{i , t} \vert {f}_{ψ} ( {z}_{i , t} ) ) \qquad [ Equation 4 ]$$

Referring to Equation 4, f_{ψ}(z_{i,t}) may correspond to an output [symbol] of the decoder model 602. The decoder model 602 may model a probability distribution p_{ψ} that reconstructs original data from the latent vector z. This probabilistic decoding process may ensure that the reconstructed UE state reflects network instability resulting from the integration of αₜ.

A loss function 616 may be calculated based on an output of the decoder model 602. In an embodiment, in order to achieve optimal encoding, a VAE model including the encoder model 600 and the decoder model 602 may be trained to maximize an ‘evidence lower bound’ (ELBO). Accordingly, the VAE model may accurately reconstruct input data and ensure a structured latent space. An ELBO objective [symbol] (φ, ψ; UE_{i,t}) may be expressed as shown in Equation 5.

$$ℒ ( φ . ψ ; {UE}_{i , t} ) = {𝔼}_{{q}_{φ} ( {z}_{i , t} \vert {UE}_{i , t} )} [ log {p}_{ψ} ( {UE}_{i , t} \vert {z}_{i , t} ) ] - KL ( {q}_{φ} ( {z}_{i , t} \vert {UE}_{i , t} ) \vert \vert p ( {z}_{i , t} ) ) \qquad [ Equation 5 ]$$

$$In Equation 5 , KL ( {q}_{φ} ( z \vert {UE}_{i , t} ) \vert \vert p ( {z}_{i , t} ) )$$

may correspond to Kullback-Leibler (KL) divergence. The KL divergence may regularize z_{i,t} by matching the latent representation z_{i,t} to a prior distribution p(z_{i,t}). [symbol] (φ, ψ; UE_{i,t}) may be referred to as a training error or loss function. Based on the loss function 616, weight matrices of the encoder model 600 and the decoder model 602 may be updated.

A training algorithm of the encoder model 600 and the decoder model 602 of FIG. 6 may be expressed as shown in Table 1. In Table 1, p_{φ} may correspond to the encoder model 600, and q_{ψ} may correspond to the decoder model 602. [symbol] _{VAE} may correspond to a loss function of the VAE.

TABLE 1

```
Training Phase
Initialize: φ, ψ
for epoch = 1, . . . , epochs do
  Sample mini-batch of {UE_{i,t}}
  for i, t in mini-batch do
    z_{i,t} ~ q_{φ}(z_{i,t}|UE_{i,t}) = [symbol]   (z_{i,t}|μ_{φ}(UE_{i,t}), aₜ)
    UE_{i,t} ~ p_{ψ}(UE_{i,t}|z_{i,t}) [symbol]
  _{VAE} = [symbol]   _{q}_{_{φ}} [log p_{ψ}(UE_{i,t}|z_{i,t})] − KL(q_{φ}||p)
  φ, ψ ← φ, ψ − α∇_{φ,ψ} [symbol]   _{VAE}
```

In an embodiment, one or more hyperparameters may be predefined for training the encoder model 600 and the decoder model 602. For example, various hyperparameters such as latent size, encoder hidden layers, decoder hidden layers, type of activation function, training rate, batch size, or number of training epochs may be predefined.

In an embodiment, the encoder model 600 may be trained for at least one of other types of network entities as well as UEs. For example, the encoder model 600 may be trained based on data collected from at least one of network entities included in a base station (e.g., the base station 14 of FIG. 1) (e.g., an RU, a distributed unit (DU), and/or a centralized unit (CU)) or network entities included in a core network (e.g., the core network 12 of FIG. 1) (e.g., access and mobility management function (AMF), session management function (SMF), user plane function (UPF), policy control function (PCF), authentication server function (AUSF), unified data management (UDM), network slice selection function (NSSF), and/or network exposure function (NEF)). The above-described network entities are only examples, and the disclosure is not limited to the above examples.

In an embodiment, the electronic device 100 may include a plurality of encoder models trained for different network entities. For example, the electronic device 100 may include not only the encoder model 400 trained based on UE data but also encoder models trained based on data for other network entities, for example, a base station or a core network. The electronic device 100 may identify a source of obtained network data and may select an encoder model corresponding to the source from among the plurality of encoder models. For example, based on obtained network data, the electronic device 100 may identify that a source of network data corresponding to TTI t is a UE. The electronic device 100 may select an encoder model trained based on UE data from among the plurality of encoder models. The electronic device 100 may generate a network embedding from the network data corresponding to TTI t by using the selected encoder model. Accordingly, the performance of the network embedding may be improved.

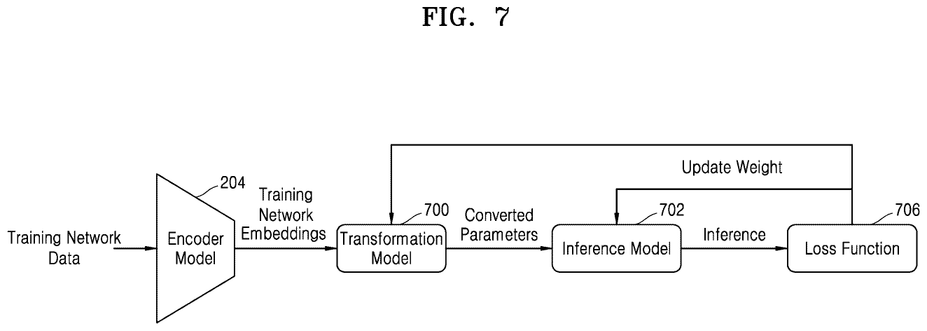

FIG. 7 illustrates an example of training a transformation model 700 and an inference model 702, according to an embodiment of the disclosure.

Referring to FIG. 7, the transformation model 700 and the inference model 702 may be trained by using the encoder model 204 that is already trained. The encoder model 204 may generate training network embeddings based on training network data. The training network embeddings may be input to the transformation model 700. Converted parameters may be input to the inference model 702. The inference model 702 may perform inference based on the converted parameters. A loss function 706 may be calculated based on the inference of the inference model 702. Weight matrices of the transformation model 700 and the inference model 702 may be updated based on the loss function 706. The training network embeddings may be used as part of an input to the inference model 702, and thus, the decision of the inference model 702 may reflect uncertainty of a network state.

In an embodiment, the inference model 702 may be based on deep reinforcement learning. For example, the inference model 702 may be implemented by using a deep Q network (DQN) algorithm. For the DQN-based inference model 702, the loss function 706 may be calculated as shown in Equation 6.

$${ℒ}_{DQN} = {𝔼}_{( {Z}_{t} , {a}_{t} , {r}_{t} , {Z}_{t + 1} ) \sim ℬ} [ {( {r}_{t} + γ {max}_{{a}_{t}^{′}} {Q}_{θ} ( {Z}_{t + 1} , {a}_{t}^{′} ) - {Q}_{θ} ( {Z}_{t} , {a}_{t} ) )}^{2} ] \qquad [ Equation 6 ]$$

Referring to Equation 6, [symbol] _{DQN} correspond to a loss function. β may represent a mini-batch sampled from a replay memory. rₜ may represent an immediate reward. γ may represent a discount factor. [symbol] may correspond to a policy network of a DQN.

$${a}_{t}^{′}$$

may represent an action that maximizes a Q-value in a next state Zₜ₊₁.

In an embodiment, the inference model 702 may be implemented by using a proximal policy optimization (PPO) algorithm. For the PPO-based inference model 702, the loss function 706 may be calculated as shown in Equation 7.

$${ℒ}_{PPO} = {𝔼}_{t} [ min ( {ρ}_{t} ( θ ) {A}_{t} , clip ( {ρ}_{t} ( θ ) , 1 - ϵ , 1 + ϵ ) {A}_{t} ) ] \qquad [ Equation 7 ]$$

In the above Equation 7, [symbol] _{PPO} may correspond to a loss function.

$${ρ}_{t} ( θ ) = \frac{{π}_{θ} ( {a}_{t} \vert {Z}_{t} )}{{π}_{old} ( {a}_{t} \vert {Z}_{t} )}$$

may represent a ratio of a new policy π_{θ} to an old policy π_{old}. For clarity, a term π_{θ}(αₜ|Zₜ) may be used. A clipping operation clip (pₜ(θ), 1−ϵ, 1+ϵ) may limit ρₜ(θ) (to a range [1−ϵ, 1+ϵ], thereby preventing an update from excessively deviating from the previous policy. The limitation of the clipping operation may help stabilize training by preventing a large policy update that may destabilize a process of training a model. A term Aₜ=rₜ+γV_{θ}_{_{critic}}(Zₜ₊₁)−V_{θ}_{_{critic}}(Zₜ) may represent an advantage at time t, calculated based on a reward rₜ and a value function V_{θ}_{_{critic}} for critic.

A training algorithm of the inference model 702 of FIG. 7 may be expressed as shown in Table 2.

TABLE 2

```
Training Phase:
Initialize: θ, V_{θ}_{_{critic}}
for episode = 1, . . . , episodes do
  for t = 1, 2, ..., T (each TTI) do
      Zₜ = {z_{i,t}|z_{i,t} = μ_{φ} (UE_{i,t}) + \sqrt{aₜ} · ∈, ∈ ~ [symbol]   (0, 1)}
      Zₜ ← σ (W_{Q} (Zₜ) · W_{K} (Zₜ)^{T}) · W_{V} (Zₜ)
  If the inference model is based on PPO then
    for i do
      aₜ ~ π_{θ} (aₜ|Zₜ)
    Store (Zₜ, aₜ, log π_{θ} (aₜ|Zₜ), V_{θ}_{_{critic}} (Zₜ), rₜ)
    Aₜ = rₜ + γV_{θ}_{_{critic}} (Zₜ₊₁) − V_{θ}_{_{critic}} (Zₜ)
    θ ← θ + α∇_{θ} [symbol]   _{PPO}
    θ_{critic} ← θ_{critic} − α∇_{θ}_{_{critic}} [symbol]   _{critic}
  else if the inference model is based on DQN then
    for i do
    aₜ = arg maxₐ [symbol]   _{θ} (Zₜ, a)
    Store (Zₜ, aₜ, rₜ, Zₜ₊₁)
    θ ← θ − α∇_{θ} [symbol]   _{DQN}
```

In an embodiment, one or more hyperparameters for training the inference model 702 may be predefined or adaptively adjusted. For example, for training the DON-based inference model 702, one or more hyperparameters such as action dimension, hidden layers, training rate, discount factor, target update frequency, replay buffer size, batch size, epsilon (exploration rate), optimization algorithm, or mini-batch may be predefined. For training the PPO-based inference model 702, one or more hyperparameters such as action dimension, hidden layers, training rate, discount factor, clipping rate, entropy coefficient, value coefficient, maximum gradient norm, optimization algorithm, or mini-batch size may be predefined.

In an embodiment, the encoder model 204 may be trained first, prior to training the transformation model 208 and the inference model 210. By using the encoder model 204 trained for network embeddings, the inference model 210 may be trained for the network embeddings. For example, the inference model 210 may be based on DQN or PPO. The DQN-based or PPO-based model may be trained based on an algorithm described in Table 2. For example, the inference model 210 may be based on a regression model such as linear regression or logistic regression. The regression-based model may be trained by using a loss function such as a ‘mean square error’ (MSE).

In an embodiment, as the inference model 210 is trained, one or more weights or parameters of the transformation model 208 may be trained together. For example, the transformation model 208 may be or may correspond to a self-attention-based model, and as the inference model 210 is updated, weight matrices (e.g., a query weight matrix, a key weight matrix, and/or a value weight matrix) of the self-attention-based model may be updated together.

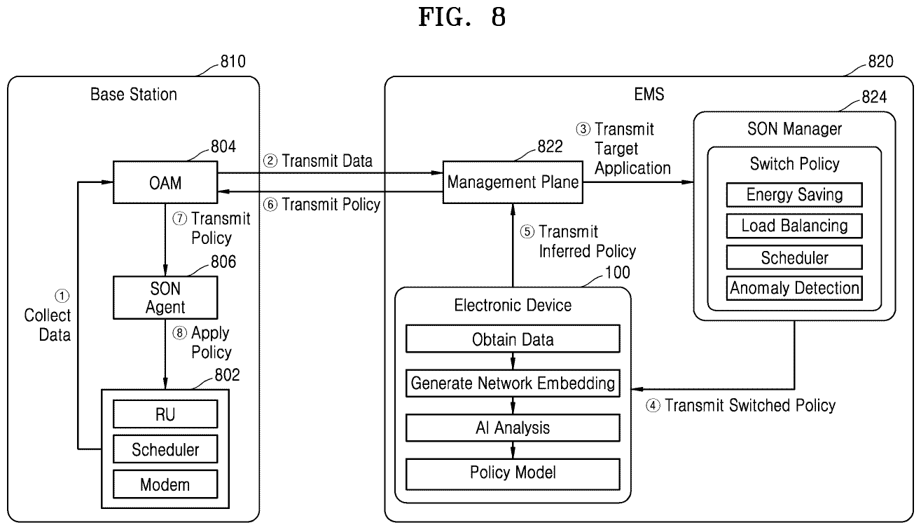

FIG. 8 illustrates an example of optimizing a policy of a base station, according to an embodiment of the disclosure.

Referring to FIG. 8, a base station 810 may include, but is not limited to, one or more network entities 802, an OAM 804, and a self-organization network (SON) agent 806. The one or more network entities 802 may include one or more wireless communication network devices such as, but are not limited to, a radio unit (RU), a scheduler, and/or a modem. For example, the base station 810 may further include other elements or may not include some elements shown in FIG. 8. At least some of the one or more network entities 802, the OAM 804, and the SON agent 806 included in the base station 810 may be elements logically, functionally, software-wise, or hardware-wise distinct from other elements.

An element management system (EMS) 820 may be connected to the base station 810 by a wire or wirelessly. The EMS 820 may collect information such as a state, performance, and an error of the base station 810. The EMS 820 may perform a function of managing settings or a configuration of the base station 810 or solving issues on a network. The EMS 820 may include, but is not limited to, a management plane 822, the electronic device 100, and a SON manager 824. For example, the EMS 820 may further include other elements, or may not include some elements shown in FIG. 8. For example, the electronic device 100 is an external module, an external server, or an external device of the EMS 820, and may be connected to or communicate with the EMS 820 by a wire or wirelessly. At least some of the management plane 822, the electronic device 100, or the SON management module 824 included in the EMS 820 may be elements logically, functionally, software-wise, or hardware-wise distinct from other elements. In an embodiment, the electronic device 100 may be referred to as an AI server or an AI server device.

The OAM 804 of the base station 810 may collect, obtain, or store statistical data about a wireless network of the base station 810. For example, the OAM 804 may collect or obtain statistical information of a communication network from the one or more network entities 802, for example, the RU, the scheduler, or the modem ((1) Collect data). The OAM 804 may transmit the collected or obtained statistical data to the management plane 822 of the EMS 820 ((2) Transmit data).

The management plane 822 may manage a configuration of network equipment and system, monitor performance, and/or maintain network entities. For example, the management plane 822 may configure initial settings of one or more network entities directly or indirectly connected to the EMS 820 and may adjust the settings. The management plane 822 may measure or estimate performance indicators of the one or more network entities directly or indirectly connected to the EMS 820. The management plane 822 may detect and recover a fault in the network. The management plane 822 may manage a security policy and access control of the network. The management plane 822 may manage firmware and/or software of the one or more network entities directly or indirectly connected to the EMS 820.

The management plane 822 may determine a target application from among a plurality of applications. For example, the plurality of applications may include an application for energy saving, an application for load balancing, an application for a scheduler, and/or an application for anomaly detection. For example, the management plane 822 may determine an application for a function or effect to be optimized through AI-based network analysis, from among the plurality of applications, as a target application. The management plane 822 may transmit information about the determined target application to an AI server 240 ((3) Transmit target application).

The SON manager 824 may perform an auto-configuration, auto-optimization, and/or auto-healing function of the network. For example, the SON manager 824 may automatically register a new base station to the network, may automatically set a neighboring cell list, and/or may automatically adjust an initial configuration of each base station. The SON manager 824 may optimize cell coverage of the base station 820, may manage interference, and/or may optimize handover. The SON manager 824 may automatically recover a fault of the base station 820, and/or may detect and prevent a fault of the base station 820 in advance.

The SON manager 824 may determine parameters and/or policies to be inferred through the electronic device 100, based on the information about the target application received from the management plane 822. For example, the SON manager 824 may select a policy for performing AI-based analysis from among a plurality of policies supported by the electronic device 100, based on the information about the target application. The selected policy for performing AI-based analysis may be a policy corresponding to the target application. For example, based on the target application being an application for energy saving, the SON manager 824 may determine (or select or switch to) an energy saving policy as the policy for performing AI-based analysis. The SON manager 824 may transmit the switched policy to the electronic device 100 ((4) Transmit switched policy).

The electronic device 100 may infer an optimal policy and/or parameter based on the policy determined by the manager 824. The electronic device 100 may obtain wireless network data, and may generate network embeddings by using the encoder model 204. The electronic device 100 may infer an optimal parameter or policy based on the network embeddings by using the transformation model 208 and an inference model corresponding to the switched policy. The electronic device 100 may provide the inferred parameter or policy to the management plane 822 ((5) Transmit inferred policy).

In an embodiment, the electronic device 100 may include a plurality of inference models trained for different objectives. For example, the electronic device 100 may include an inference model trained to recommend an optimal parameter or policy associated with energy saving, an inference model trained to recommend an optimal parameter or policy associated with load balancing, an inference model trained to output a parameter or policy associated with scheduling, or an inference model trained to recommend an optimal parameter or policy associated with anomaly detection. The electronic device 100 may select an inference model corresponding to the policy determined by the SON manager 824 from among the plurality of inference models, and may infer an optimal parameter or policy by using the selected inference model. For example, based on the policy determined by the SON manager 824 being energy saving, the electronic device 100 may select the inference model trained to recommend an optimal parameter or policy associated with energy saving from among the plurality of inference models.

In an embodiment, AI analytics may be performed based on network embeddings. The electronic device 100 may predict a network state of the base station 820 based on the network embeddings. Based on the predicted network state, the electronic device 100 may determine whether to input the network embedding to the inference model 210. For example, the electronic device 100 may determine, in real time, whether optimization of a parameter and/or policy of the base station 820 is necessary based on the predicted network state. Based on determination that optimization of the parameter and/or policy of the base station 820 is necessary, the electronic device 100 may infer a new policy and/or parameter by inputting the network embeddings to the inference model 210.

In an embodiment, the electronic device 100 may store at least one of the network embeddings or a result of AI analytics in a database of the electronic device 100. The stored data may be used for training or inference of an inference model.

The management plane 822 may transmit the policy inferred by the electronic device 100 to the OAM 804 of the base station 820 ((6) Transmit policy). The OAM 804 may transmit the inferred policy to the SON agent 806 ((7) Transmit policy). The SON agent 806 may perform optimization of the base station 820 based on a request or a command from the SON manager 824. For example, the SON agent 806 may apply or reflect the policy inferred by the electronic device 100 to an application (e.g., at least one of the one or more network entities 802) ((8) Apply policy). For example, the SON agent 806 may determine parameters associated with control of the network, for example, one or more parameters to be used in the target application, based on the policy inferred by the electronic device 100.

According to an embodiment of the disclosure, the electronic device 100 may generate network embeddings from wireless network data, and may input the network embeddings to an inference model for a wireless network. The electronic device 100 may generate network embeddings by extracting a feature of a wireless network based on a generative AI model. The generative AI model may be an algorithm capable of freely generating data by changing a specific value of input data. To this end, the generative AI model may be pre-trained to extract a feature of input data and freely vary an output according to a change in a specific value. There are cases where a causal relationship between indicators or parameters is not identified in the network. Also, network data collected through a base station may be affected by a parameter of the base station. The electronic device 100 may utilize an AI technique to extract network information by removing base station parameter information from collected network data. Accordingly, the accuracy of an inference model may be improved.

According to an embodiment of the disclosure, the electronic device 100 may input network embeddings to the transformation model 208 that converts the network embeddings into a predefined number of parameters. Network data obtained from a wireless network may include information of a plurality of network entities, for example, a plurality of UEs. The number of network entities belonging to the wireless network may change in real time. For example, the number of UEs connected to the base station 810 may change continuously. Even when the number of network embeddings changes over time, the electronic device 100 may fix the size of an input vector input to the inference model 210 by using the transformation model 208. Accordingly, even when the number of network embeddings at a specific time point changes, the inference model 210 may operate.

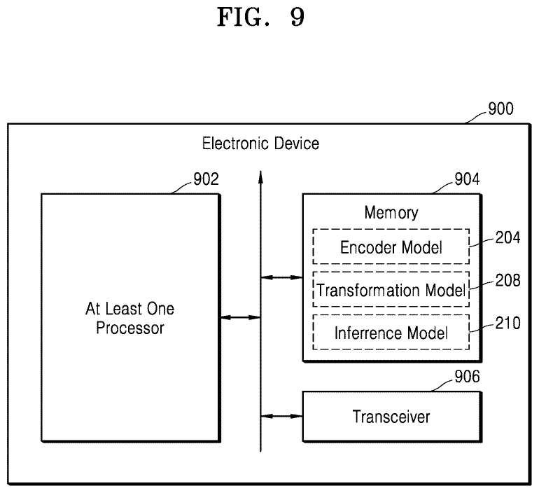

FIG. 9 illustrates an example of a block diagram of an electronic device 900, according to an embodiment of the disclosure.

The electronic device 900 of FIG. 9 may be a computing device or a server device that recommends a parameter or a policy for a network entity, and/or predicts a network performance indicator. For example, the electronic device 900 may include a device that infers one or more parameters or policies to be used for network control by using an AI model. For example, the electronic device 900 is a communication device constituting a wireless network, and may be a server device included in a network entity such as a base station or an EMS. The electronic device 900 may be a separate server device that is located outside a wireless network, and infers one or more parameters or policies to be used in the wireless network or predicts a network performance indicator.

In an embodiment, an electronic device for training or updating at least one of an AI model for extracting a network feature, an AI model for converting network embeddings into a predefined number of parameters, or an AI model for inferring a network entity parameter, a network entity policy, or a network performance indicator may be the same as or different from the electronic device 900 for performing prediction or inference by using AI models. For example, when the electronic device for training or updating an AI model and the electronic device 900 (i.e., electronic device for performing prediction or inference) are different from each other, the electronic device 900 may receive a trained or updated AI model from the electronic device for training or updating an AI model.

In an embodiment, an AI model may be dynamically updated when a prediction or inference operation is performed. For example, weights of at least some of the encoder model 204, the transformation model 208, or the inference model 210 may be dynamically updated when a prediction or inference operation is performed. For example, when the electronic device for updating an AI model and the electronic device 900 are the same, the electronic device 900 may perform prediction or inference by using the AI model and may update the AI model at the same time. For example, when the electronic device for updating an AI model and the electronic device 900 are different from each other, the electronic device for updating an AI model may receive data identified, generated, or calculated by the electronic device 900 while performing prediction or inference by using the AI model, and may update the AI model based on the received data.

In an embodiment, the electronic device 900 may include, but is not limited to, at least one processor 902, memory 904, and a transceiver 906.

The processor 902 may be electrically connected to components included in the electronic device 900 and may execute operations or data processing related t control and/or communication of the components included in the electronic device 900. In an embodiment, the processor 902 may load and process a request, a command, or data received from at least one of other components into the memory and may store a processing result in the memory. In an embodiment, the processor 902 may process input data or control other components to process input data according to data, operation rules, algorithms, methods, or models stored in the memory 904. For example, the processor 902 may perform operations of predefined operation rules, algorithms, methods, modules, or AI models (e.g., neural network models) stored in the memory 904 by using input data. The at least one processor may execute program instructions individually or collectively to achieve or perform various functions according to the disclosure.

According to one or more embodiments of the disclosure, the processor 902 may include at least one of a general-purpose processor such as a central processing unit (CPU), an application processor (AP), or a digital signal processor (DSP), a graphics-specific processor such as a graphic processing unit (GPU) or a vision processing unit (VPU), or an AI-specific processor such as a neural processing unit (NPU). For example, When the processor 902 is an AI-specific processor, the AI-specific processor may be designed as a hardware structure specialized for processing a specific AI model.

The processor 902 may include various types of processing circuitry and/or a plurality of processors. For example, the term “processor” used in the disclosure including the claims may include various types of processing circuitry including at least one processor. One or more of the at least one processor may be configured to perform one or more functions in the disclosure, individually and/or collectively in a distributed method. In the disclosure, when ‘a processor’, ‘at least one processor’, or ‘one or more processors’ are described as being configured to perform a plurality of functions, this may include a situation where one processor performs some of functions and other processors perform others of the functions and a situation where a single processor performs all functions. Also, the at least one processor may include a combination of processors for performing various functions in a distributed fashion. The at least one processor may execute program instructions to achieve or perform various functions.

The memory 904 is electrically connected to the processor 902 and may store one or more modules, algorithms, operation rules, models (e.g., machine learning models or AI models), programs, instructions, or data related to operations of components included in the electronic device 900. For example, the memory 904 may include any non-transitory computer-readable recording medium. For example, the memory 904 may store one or more modules, algorithms, operation rules, models, programs, instructions, or data for processing and control by the processor 902. The memory 904 may include at least one type of storage medium among, but not limited to, a flash memory type, a hard disk type, a multimedia card micro type, a card type memory (e.g., an SD or XD memory), a random-access memory (RAM), a static random-access memory (SRAM), a read-only memory (ROM), an electrically erasable programmable ROM (EEPROM), a programmable ROM (PROM), a magnetic memory, a magnetic disk, and an optical disk.

In an embodiment, the memory 904 may store data and/or information identified, obtained, generated, or determined by the electronic device 900. For example, the memory 904 may store network data or a weight of each model. The memory 904 may store network embeddings generated by the encoder model 204 or an output of the inference model 210. The memory 904 may store data and/or information identified, obtained, generated, or determined by the electronic device 900 in a compressed form. In an embodiment, the memory 904 may store predefined or determined information.

In an embodiment, the electronic device 900 may include a module that performs (or is used to perform) at least one operation). Some modules for performing at least one operation of the electronic device 900 may include a plurality of sub-modules or constitute one module. A module for performing at least one operation of the electronic device 900 may be or may correspond to a hardware module, a software module, and/or a combination of the hardware module and the software module.

The memory 904 may include software modules for performing at least some of operations of the electronic device 900. In an embodiment, a module included in the memory 904 may perform an operation by being executed by the processor 902. For example, a module (or a software module) included in the memory 904 may be executed according to control or command of the processor 902, and may include a program, a model, operation rules, or an algorithm configured to perform operations of deriving output data from input data.

In an embodiment, the memory 904 may include a program, instructions, a neural network model, an AI model, an ML model, a statistical model, operation rules, or an algorithm for processing network data. For example, the memory 904 may store the encoder model 204, the transformation model 208, and the inference model 210 or a weight matrix of each model. The encoder model 204, the transformation model 208, and the inference model 210 stored in the memory 904 may be executed by the at least one processor 902.

A model included in the memory 904 may be created through training. Being created through training may mean that a foundation AI model is trained by using a number of training data by a training algorithm to create an AI model configured to perform desired characteristics (or objectives). Such training may be performed by a device itself in which AI according to the disclosure is performed or by a separate server and/or system. Examples of the training algorithm may include, but are not limited to, supervised learning, unsupervised learning, semi-supervised learning, or reinforcement learning.

The transceiver 906 may perform functions for transmitting and receiving a signal, in a wired communication environment. The transceiver 906 may include a wired interface for controlling direct connection between devices through a transmission medium (e.g., copper wire or optical fiber). For example, the transceiver 906 may transmit an electrical signal to another device through a copper wire or may perform conversion between an electrical signal and an optical signal. The transceiver 906 may communicate with another component in a wireless communication system or a wireless network.

The transceiver 906 may include an antenna unit. The transceiver 906 may include at least one antenna array including a plurality of antenna elements. From a hardware perspective, the transceiver 906 may include a digital circuit and/or an analog circuit (e.g., a radio frequency integrated circuit (RFIC)). The digital circuit and/or the analog circuit may be implemented in one package. Also, the transceiver 906 may include a plurality of RF chains. The transceiver 906 may perform beamforming. The transceiver 906 may apply a beamforming weight to a signal to be transmitted and received, in order to provide directionality according to settings of the processor 902. According to an embodiment of the disclosure, the transceiver 906 may include a radio frequency (RF) block (or RF unit). The transceiver 906 may transmit a synchronization signal, a reference signal, system information, a message, a control message, a stream, control information, or data.

An electronic device according to an embodiment of the disclosure may include at least one processor. The electronic device may include memory including one or more storage media in which one or more instructions are stored. The one or more instructions, when executed by the at least one processor, may cause the electronic device to obtain network entity data associated with each network entity from each of one or more network entities. The one or more instructions, when executed by the at least one processor, may cause the electronic device to generate network embeddings based on the network entity data associated with each network entity, by using an encoder model, for each of the one or more network entities. The one or more instructions, when executed by the at least one processor, may cause the electronic device to convert the network embeddings into a predefined number of parameters by using a transformation model. The one or more instructions, when executed by the at least one processor, may cause the electronic device to input the predefined number of parameters to an inference model. The one or more instructions, when executed by the at least one processor, may cause the electronic device to obtain, from the inference model, an output regarding the predefined number of parameters. The one or more instructions, when executed by the at least one processor, may cause the electronic device to determine one or more parameters associated with control of a network, based on an output of the inference model.

Additionally or alternatively, the one or more instructions, when executed by the at least one processor, may cause the electronic device to input network entity data obtained from a first network entity among the one or more network entities to the encoder model. The one or more instructions, when executed by the at least one processor, may cause the electronic device to obtain a probability distribution for the first network entity from the encoder model. The one or more instructions, when executed by the at least one processor, may cause the electronic device to generate a network embedding for the first network entity by performing sampling based on the probability distribution for the first network entity.

The one or more instructions, when executed by the at least one processor, may cause the electronic device to extract a sample from the probability distribution for the first network entity. The one or more instructions, when executed by the at least one processor, may cause the electronic device to generate the network embedding for the first network entity based on the sample and Gaussian noise.

Additionally or alternatively, the transformation model 208 may be a model based on self-attention. The one or more instructions, when executed by the at least one processor, may cause the electronic device to combine the network embeddings. The one or more instructions, when executed by the at least one processor, may cause the electronic device to input the combined network embeddings to the transformation model 208. The one or more instructions, when executed by the at least one processor, may cause the electronic device to obtain the predefined number of parameters from the transformation model.

Additionally or alternatively, the network entity data may be obtained periodically. The network embedding for each network entity may be generated for each period in which the network entity data is obtained.

The one or more instructions, when executed by the at least one processor, may cause the electronic device to combine the network embeddings generated for each period in which the network entity data is obtained. The one or more instructions, when executed by the at least one processor, may cause the electronic device to input the network embeddings combined for each period in which the network entity data is obtained to the transformation model. The one or more instructions, when executed by the at least one processor, may cause the electronic device to obtain the predefined number of parameters for each period in which the network entity data is obtained, from the transformation model.

Additionally or alternatively, the inference model may output one or more values used to determine one or more parameters or policies for network entities included in the network based on the predefined number of parameters.

Additionally or alternatively, the inference model may output one or more values for predicting a performance indicator of the network or a state of the network based on the predefined number of parameters.

Additionally or alternatively, the encoder model may be trained by inputting training network entity data for a single network entity to the encoder model. The encoder model may be trained by obtaining a probability distribution for the single network entity from the encoder model. The encoder model may be trained by obtaining a sample for the single network entity based on the probability distribution for the single network entity and Gaussian noise. The encoder model may be trained by reconstructing network entity data for the single network entity based on the sample, by using a decoder model. The encoder model may be trained by calculating a loss function based on the network entity data reconstructed by the decoder model. The encoder model may be trained by updating one or more weights of the encoder model and one or more weights of the decoder model based on the loss function.

Additionally or alternatively, the inference model and the transformation model may be trained by generating a training network embedding for each network entity from training network entity data for at least one network entity, by using the encoder model. The inference model and the transformation model may be trained by converting the training network embeddings into the predefined number of parameters, by using the transformation model. The inference model and the transformation model may be trained by inputting the parameters converted from the training data embeddings to the inference model. The inference model and the transformation model may be trained by calculating a loss function based on an output of the inference model based on the parameters converted from the training network embeddings. The inference model and the transformation model may be trained by updating the transformation model and the inference model based on the loss function.

In the disclosure, the same description as that made with reference to FIGS. 1 to 9 will be omitted, and an embodiment described in at least one of FIGS. 1 to 9 may be combined and applied or implemented.

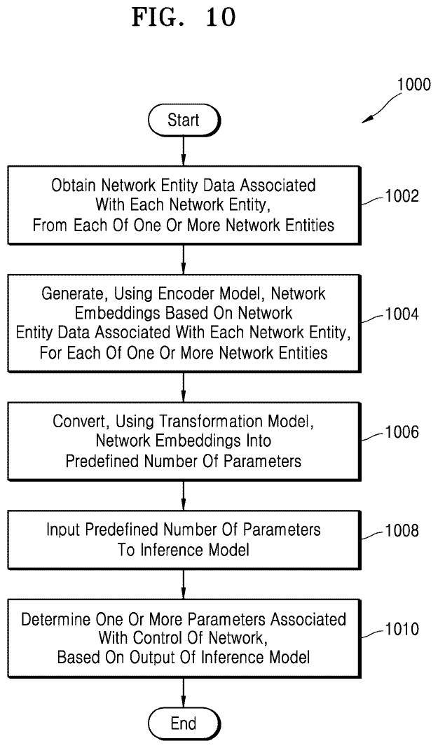

FIG. 10 illustrates an example of a flowchart of a method 1000, according to an embodiment of the disclosure.

Referring to FIG. 10, the method 1000 may include operations 1002, 1004, 1006, 1008, and 1010. In an embodiment, the method 1000 may be performed by the electronic device 100. However, the disclosure is not limited to the above example embodiment. For example, the operations 1002, 1004, 1006, 1008, and 1010 may be performed by any electronic device individually or in combination. The method according to an embodiment of the disclosure is not limited to the method illustrated in FIG. 10. Any one of operations shown in FIG. 10 may be omitted or other operations may be further included in the embodiment of FIG. 10. In an embodiment, at least some of the operations 1002, 1004, 1006, 1008, and 1010 may be performed in a different order.

In operation 1002, the electronic device 100 may obtain network entity data associated with each network entity, from each of one or more network entities. For example, the electronic device 100 may obtain UE data associated with each UE, from one or more UEs. In an embodiment, in operation 1002, the electronic device 100 may obtain network entity data associated with at least one network entity. For example, the electronic device 100 may obtain UE data associated with at least one UE.

In operation 1004, the electronic device 100 may generate, using the encoder model 204, network embeddings based on the network entity data associated with each network entity, for each of the one or more network entities. For example, the electronic device 100 may input UE data associated with a first UE to the encoder model 204, for the first UE among the one or more UEs. The encoder model 204 may output a network embedding representing a feature of the UE data associated with the first UE, in response to, or based on, the UE data associated with the first UE. In an embodiment, In operation 1004, the electronic device 100 may generate, using the encoder model 204, network embeddings based on the network entity data associated with the at least one network entity. For example, the electronic device 100 may input UE data associated with a first UE (among the one or more UEs) to the encoder model 204. The encoder model 204 may output a network embedding representing a feature of the UE data associated with the first UE, in response to, or based on, the UE data associated with the first UE.

In operation 1006, the electronic device 100 may convert, using the transformation model 208, the network embeddings into a predefined number of parameters. For example, the electronic device 100 may input the network embeddings generated through operation 1004 to the transformation model 208. The transformation model 208 may convert the network embeddings into a predefined number of parameters (or an output matrix having a fixed size).

In operation 1008, the electronic device 100 may input the predefined number of parameters converted in operation 1006 to the inference model 210. The electronic device 100 may obtain, from the inference model 210, an output regarding the predefined number of parameters. In operation 1010, the electronic device 100 may determine one or more parameters associated with control of a network, based on the output of the inference model 210.

A method according to an embodiment of the disclosure may include obtaining network entity data associated with each network entity, from each of one or more network entities. The method may include generating, using an encoder model, network embeddings based on the network entity data associated with each network entity, for each of the one or more network entities. The method may include converting, using a transformation model, the network embeddings into a predefined number of parameters. The method may include inputting the predefined number of parameters to an inference model. The method may include determining one or more parameters associated with control of a network, based on an output of the inference model.

Additionally or alternatively, the generating, using the encoder model, of the network embeddings may include inputting, to the encoder model, network entity data obtained from a first network entity among the one or more network entities. The generating, using the encoder model, of the network embeddings may include obtaining a probability distribution for the first network entity, from the encoder model. The generating, using the encoder model, of the network embeddings may include generating a network embedding for the first network entity by performing sampling based on the probability distribution for the first network entity.

Additionally or alternatively, the generating of the network embedding for the first network entity may include extracting a sample from the probability distribution for the first network entity. The generating of the network embedding for the first network entity may include generating the network embedding for the first network entity based on the sample and Gaussian noise.

Additionally or alternatively, the transformation model may be based on self-attention. The converting of the network embeddings into the predefined number of parameters may include combining the network embeddings. The converting of the network embeddings into the predefined number of parameters may include inputting the combined network embeddings to the transformation model. The converting of the network embeddings into the predefined number of parameters may include obtaining the predefined number of parameters from the transformation model.

Additionally or alternatively, the obtaining of the network entity data may comprise obtaining the network entity data periodically. The generating of the network embeddings for the one or more network entities comprises generating the network embedding for each network entity for each period in which the network entity data is obtained.

Additionally or alternatively, the converting of the network embeddings into the predefined number of parameters may include combining network embeddings generated for each period in which the network entity data is obtained. The converting of the network embeddings into the predefined number of parameters may include inputting, to the transformation model, the network embeddings combined for each period in which the network entity data is obtained. The converting of the network embeddings into the predefined number of parameters may include obtaining the predefined number of parameters for each period in which the network entity data is obtained, from the transformation model.

Additionally or alternatively, the inference model may output one or more values used to determine one or more parameters or policies for network entities included in the network based on the predefined number of parameters.

Additionally or alternatively, the inference model may output one or more values for predicting a performance indicator of the network or a state of the network based on the predefined number of parameters.

Additionally or alternatively, the encoder model may be trained by inputting, to the encoder model, training network entity data for a single network entity. The encoder model may be trained by obtaining a probability distribution for the single network entity from the encoder model. The encoder model may be trained by obtaining a sample for the single network entity based on the probability distribution for the single network entity and Gaussian noise. The encoder model may be trained by reconstructing, using a decoder model, network entity data for the single network entity based on the sample. The encoder model may be trained by calculating a loss function based on the network entity data reconstructed by the decoder model. The encoder model may be trained by updating one or more weights of the encoder model and one or more weights of the decoder model.

Additionally or alternatively, the inference model and the transformation model may be trained by generating, using the encoder model, training network embeddings for each network entity from training network entity data for at least one network entity. The inference model and the transformation model may be trained by converting, using the transformation model, the training network embeddings into the predefined number of parameters. The inference model and the transformation model may be trained by inputting, to the inference model, the parameters converted from the training network embeddings. The inference model and the transformation model may be trained by obtaining, from the inference model, an output regarding the converted parameters. The inference model and the transformation model may be trained by calculating a loss function based on the output of the inference model based on the parameters converted from the training network embeddings. The inference model and the transformation model may be trained by updating the transformation model and the inference model based on the loss function.

According to an embodiment of the disclosure, a computer-readable recording medium may record a program for performing any combination of methods, steps, and operations according to an embodiment of the disclosure on a computer.

The machine-readable storage medium may be provided as a non-transitory storage medium. Here, ‘non-transitory’ means that the storage medium does not include a signal (e.g., an electromagnetic wave) and is tangible, but does not distinguish whether data is stored semi-permanently or temporarily in the storage medium. For example, the ‘non-transitory storage medium’ may include a buffer in which data is temporarily stored.

According to an embodiment of the disclosure, methods may be provided in a computer program product. The computer program product may be a product purchasable between a seller and a purchaser. The computer program product may be distributed in the form of a machine-readable storage medium (e.g., a compact disc read-only memory (CD-ROM)), or distributed (e.g., downloaded or uploaded) online via an application store or between two user devices (e.g., smartphones) directly. When distributed online, at least part of the computer program product (e.g., a downloadable application) may be temporarily generated or at least temporarily stored in a machine-readable storage medium, such as memory of a server of a manufacturer, a server of an application store, or a relay server.

Although the embodiments have been described by the limited embodiments and the drawings as described above, various modifications and variations may be made by one of ordinary skill in the art from the above description. For example, the described techniques may be performed in a different order from the described method, and/or the described elements such as a computer system and a module may be combined or integrated in a different form from the described method, or may be replaced or substituted by other components or equivalents to achieve appropriate results.

What is claimed is:

1. A method comprising:
obtaining network entity data associated with each network entity, from each of one or more network entities;
generating, using an encoder model, network embeddings for the one or more network entities, based on the network entity data;
converting, using a transformation model, the network embeddings into a predefined number of parameters;
inputting the predefined number of parameters to an inference model;
obtaining, from the inference model, an output regarding the predefined number of parameters; and
determining, based on the output of the inference model, one or more parameters associated with control of a network.

2. The method of claim 1, wherein the generating, using the encoder model, of the network embeddings comprises:
inputting, to the encoder model, network entity data obtained from a first network entity among the one or more network entities;
obtaining, from the encoder model, a probability distribution for the first network entity; and
generating a network embedding for the first network entity by performing sampling based on the probability distribution for the first network entity.

3. The method of claim 2, wherein the generating of the network embedding for the first network entity comprises:
extracting a sample from the probability distribution for the first network entity; and
generating the network embedding for the first network entity based on the sample and Gaussian noise.

4. The method of claim 1, wherein the transformation model is based on self-attention, and
wherein the converting of the network embeddings into the predefined number of parameters comprises:
combining the network embeddings;
inputting the combined network embeddings to the transformation model; and
obtaining, from the transformation model, the predefined number of parameters.

5. The method of claim 1, wherein the obtaining of the network entity data comprises obtaining the network entity data periodically, and
wherein the generating of the network embeddings for the one or more network entities comprises generating the network embedding for each network entity for each period in which the network entity data is obtained.

6. The method of claim 5, wherein the converting of the network embeddings into the predefined number of parameters comprises:
combining network embeddings generated for each period in which the network entity data is obtained;
inputting, to the transformation model, the network embeddings combined for each period in which the network entity data is obtained; and
obtaining, from the transformation model, the predefined number of parameters for each period in which the network entity data is obtained.

7. The method of claim 1, wherein the inference model is configured to output one or more values for determining one or more parameters or policies for network entities in the network, based on the predefined number of parameters.

8. The method of claim 1, wherein the inference model is configured to output one or more values for predicting a performance indicator of the network or a state of the network, based on the predefined number of parameters.

9. The method of claim 1, wherein the encoder model is trained by:
inputting, to the encoder model, training network entity data for a single network entity;
obtaining, from the encoder model, a probability distribution for the single network entity;
obtaining a sample for the single network entity based on the probability distribution for the single network entity and Gaussian noise;
reconstructing, using a decoder model, network entity data for the single network entity, based on the sample;
calculating a loss function based on the network entity data reconstructed by the decoder model; and
updating one or more weights of the encoder model and one or more weights of the decoder model, based on the loss function.

10. The method of claim 1, wherein the inference model and the transformation model are trained by:
generating, using the encoder model, a training network embedding for each network entity from training network entity data for at least one network entity;
converting, using the transformation model, the training network embeddings into the predefined number of parameters;
inputting, to the inference model, the parameters converted from the training network embeddings;
obtaining, from the inference model, an output regarding the converted parameters;
calculating a loss function based on the output of the inference model and based on the parameters converted from the training network embeddings; and
updating the transformation model and the inference model based on the loss function.

11. A computer-readable recording medium having recorded thereon a program for performing the method of claim 1 on a computer.

12. An electronic device comprising:
at least one processor; and
memory storing one or more instructions,
wherein the one or more instructions, when executed by the at least one processor individually or collectively, cause the electronic device to:
obtain, from each of one or more network entities, network entity data associated with each network entity;
generate, using an encoder model, network embeddings for the one or more network entities, based on the network entity data;
convert, using a transformation model, the network embeddings into a predefined number of parameters;
input the predefined number of parameters to an inference model;
obtain, from the inference model, an output regarding the predefined number of parameters; and
determine, based on an output of the inference model, one or more parameters associated with control of a network.

13. The electronic device of claim 12, wherein the one or more instructions, when executed by the at least one processor individually or collectively, further cause the electronic device to:
input, to the encoder model, network entity data obtained from a first network entity among the one or more network entities;
obtain, using the encoder model, a probability distribution for the first network entity; and
generate a network embedding for the first network entity by performing sampling based on the probability distribution for the first network entity.

14. The electronic device of claim 13, wherein the one or more instructions, when executed by the at least one processor individually or collectively, further cause the electronic device to:
extract a sample from the probability distribution for the first network entity; and
generate the network embedding for the first network entity, based on the sample and Gaussian noise.

15. The electronic device of claim 12, wherein the transformation model is based on self-attention, and
wherein the one or more instructions, when executed by the at least one processor individually or collectively, further cause the electronic device to:
combine the network embeddings;
input the combined network embeddings to the transformation model; and
obtain, from the transformation model, the predefined number of parameters.

16. The electronic device of claim 12, wherein the network entity data is obtained periodically, and
wherein the network embedding for each network entity is generated for each period in which the network entity data is obtained.

17. The electronic device of claim 16, wherein the one or more instructions, when executed by the at least one processor individually or collectively, further cause the electronic device to:
combine network embeddings generated for each period in which the network entity data is obtained;
input, to the transformation model, the network embeddings combined for each period in which the network entity data is obtained; and
obtain, from the transformation model, the predefined number of parameters for each period in which the network entity data is obtained.

18. The electronic device of claim 12, wherein the inference model is configured to output one or more values for determining one or more parameters or policies for network entities in the network, based on the predefined number of parameters.

19. The electronic device of claim 12, wherein the inference model is configured to output one or more values for predicting a performance indicator of the network or a state of the network, based on the predefined number of parameters.

20. The electronic device of claim 12, wherein the encoder model is trained by:
inputting, to the encoder model, training network entity data for a single network entity;
obtaining a probability distribution for the single network entity from the encoder model;
obtaining a sample for the single network entity based on the probability distribution for the single network entity and Gaussian noise;
reconstructing, using a decoder model, network entity data for the single network entity based on the sample;
calculating a loss function based on the network entity data reconstructed by the decoder model; and
updating one or more weights of the encoder model and one or more weights of the decoder model, based on the loss function.
